(19) United States
(12) Patent Application Publication
(10) Pub. No.: US 2025/0085191 A1
(43) Pub. Date: Mar. 13, 2025

(54) 3D Refractive Index Estimation Based on Partially-Coherent Optical Diffraction Tomography (PC-ODT) and Deep Learning

(71) Applicant: George Nehmetallah, Washington, DC (US)

(72) Inventor: George Nehmetallah, Washington, DC (US)

(21) Appl. No.: 18/225,100

(22) Filed: Jul. 21, 2023

Related U.S. Application Data
(60) Provisional application No. 63/391,757, filed on Jul. 24, 2022.

(51) Int. Cl. G01M 11/02; G02B 21/08; G02F 1/29

(52) U.S. Cl. CPC G01M 11/0228; G01M 11/0207; G02B 21/08; G02F 1/294

(57) ABSTRACT

A system, a microscope, and a method for determining a three dimensional refractive index are provided. The system comprises an illumination system configured to generate an illumination beam to illuminate a target at a plurality of illumination angles; an optical system to direct the illumination beam to the target; a refocusing system positioned in a detection path and configured to perform stageless axial refocusing of a measurement beam, a detection system configured to capture an intensity stack for the plurality of illumination angles and during the axial refocusing; and a processor configured to generate a three dimensional refractive index of the target based on the intensity stack. The measurement beam is transmitted through the target.

### CROSS-REFERENCE TO RELATED APPLICATIONS

This application claims the benefit of priority from U.S. Provisional Application No. 63/391,757 filed Jul. 24, 2022 the entire content of which is incorporated herein by reference.

### BACKGROUND

Optical diffraction tomography (ODT) provides a 3D reconstruction of the refractive index (RI) for nearly optically transparent samples exhibiting weak absorption and scattering properties. Traditionally ODT approaches use specialized holographic imaging exploiting light sources with high degrees of spatial and temporal coherence, and complex hardware to achieve angular scanning of the sample illumination projection. Interferometric approaches are subject to coherent speckle and phase instabilities. Non-interferometric ODT has been demonstrated using partially-coherent sources and traditional wide-field transmission microscopes. This approach achieves a simplified hardware solution by utilizing an electronically tunable lens (ETL) to collect a series of through-focus intensity images as the axial focal depth is scanned. For samples that meet the criteria of the first Born approximation, the transport of intensity equation (TIE) provides non-interferometric access to quantitative phase and RI contrast. ODT based solely on axial scanning suffers from an incomplete representation of the 3D optical transfer function (OTF), particularly in the axial dimension. Hardware and software solutions to recover this missing resolution, commonly referred to as the “missing cone” problem, are at the core of almost all inverse scattering applications. In addition, choosing the optimal defocusing distance presents an inherent tradeoff between sensitivity and spatial resolution. While these systems have been shown to provide estimates of the transverse phase, 3D wavefield inversion is severely under-represented by the measurement space.

Traditional ODT reconstruction techniques rely on a formal definition of the forward scattering model which is used directly to solve the corresponding inverse problem. These approaches are subject to the limitations of a rigid mathematical construct, including boundary artifacts and 1^{st} order scattering approximations resulting in phase biases, low-frequency blurring, and reduced axial resolution. Deep learning (DL) approaches can deduce the complex nonlinear transformation between the input measurements and desired output without the constraints imposed by a direct definition of an optical scattering model.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present disclosure.

### SUMMARY

The present disclosure relates to a microscope system. The microscope system comprises an illumination system configured to generate an illumination beam to illuminate a target at a plurality of illumination angles; an optical system to direct the illumination beam to the target; a refocusing system positioned in a detection path and configured to perform stageless axial refocusing of a measurement beam, a detection system configured to capture an intensity stack for the plurality of illumination angles and during the axial refocusing; and a processor configured to generate a three dimensional refractive index of the target based on the intensity stack. The measurement beam is transmitted through the target.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic that shows a depiction of solving a typical tomographic inversion problem, according to one aspect of the present disclosure.

FIG. 2 is a schematic that shows the non-interferometric ODT imaging system for measurement acquisition and 3D refractive index (RI) reconstruction based on through-focus axial scanning and illumination scanning, according to one aspect of the present disclosure.

FIG. 3A is a schematic that shows the 3D rendering and z=0 axial slice for the 96×96×96 object-plane representation of the 3D scattering potential for a simulated cell phantom, according to one aspect of the present disclosure.

FIG. 3B is a schematic that-shows the 3D renderings for the image-plane representation of 3D scattering potentials, representing the multi-realizations used for training and testing support for algorithm analysis, according to one aspect of the present disclosure.

FIG. 4 is a schematic that shows the multi-slice beam propagation (MSBP) forward model operates on the scattering potential of an object to return an intensity measurement de-focused to a plane z_{f} from an incident wavefront at an angle θ=(θₓ, θ_{y}), according to one aspect of the present disclosure.

FIG. 5 is a schematic that shows the depiction of the forward scattering process that transforms 3D scattering potentials to 2D scattered fields, according to one aspect of the present disclosure.

FIG. 6 is a schematic that shows the ODT-Gradient Inverse method comprising a forward model and gradient based object update, according to one aspect of the present disclosure.

FIG. 7 is a schematic that shows the back-projection gradient update comprised of a plane-by-plane update of the reconstructed scattering potential in the direction of an intensity measurement, according to one aspect of the present disclosure.

FIG. 8A is a schematic illustration of the ODT-Deep inverse approach training procedure for the pix2pix cGAN, according to one aspect of the present disclosure.

FIG. 8B is a schematic illustration of the ODT-Deep inverse approach used in tomographic reconstruction, according to one aspect of the present disclosure.

FIG. 9 is a schematic illustration of the 3D U-Net generator network comprising convolutional encoder layers and de-convolutional decoder layers, according to one aspect of the present disclosure.

FIG. 10 is a schematic illustration of the 3D PatchGAN discriminator network, which mimics the decoder path in the generator network. according to one aspect of the present disclosure.

FIG. 11A is a schematic illustration of the reconstruction time per iteration for ODT-Gradient inverse implemented on GPU, shown for increasing measurement support and root pixels per image, according to one aspect of the present disclosure.

FIG. 11B is a schematic illustration of the training time per epoch (left) and testing time per sample (right scale) for ODT-Deep inverse implemented on GPU, shown for increasing measurement support and root pixels per image, according to one aspect of the present disclosure.

FIGS. 12A-12C are schematics of the 3D RI used as scattering potential, according to one aspect of the present disclosure.

FIGS. 13A-13C are schematics of the 3D reconstruction of RI using ODT-Gradient inverse, according to one aspect of the present disclosure.

FIGS. 14A-14C are schematics of the 3D reconstruction of RI using ODT-Deep inverse, according to one aspect of the present-disclosure.

FIG. 15 is a schematic that shows the 3D rendering of ODT forward and inverse processes for 7 de-focus planes and 36 illumination angles, according to one aspect of the present disclosure.

FIGS. 16A-16B are schematics of the RMSE of the 3D RI computed over 64 test samples for ODT-Gradient inverse as a function of optimization iteration according to one aspect of the present disclosure.

FIG. 17 is an exemplary block diagram of a computing device according to one example.

### DETAILED DESCRIPTION

Referring now to the drawings, wherein like reference numerals designate identical or corresponding parts throughout several views, the following description relates to a microscope, an optical system and associated methodology for 3D optical diffraction tomographic microscopy. The apparatus, optical systems, and methods described herein may be used for imaging biomedical specimens, including cells and tissue components.

The approaches described herein improve upon non-interferometric ODT approaches by implementing a system comprising fast axial scanning using an ETL as well as fast angular illumination scanning using a fully or partially coherent source. Angular scanning can be achieved using beam steering hardware including a digital micromirror devices (DMD), spatial light modulator (SLM), and a programmable Galvo mirror. Angular diversity can also be achieved using a 2D LED array, where individual diodes sequentially provide illumination from a discrete and well calibrated direction.

Described herein is an inversion scheme based on representing the scattering process using a 3D convolutional neural network (CNN) for improved refractive index and phase retrieval. System performance is evaluated using simulations of the optical scattering and measurement acquisition processes for an ODT imaging system utilizing illumination and defocus scanning. Reconstruction performance is evaluated relative to an optimization technique based on an iterative back-projection gradient descent method using a multiple in-plane scattering model.

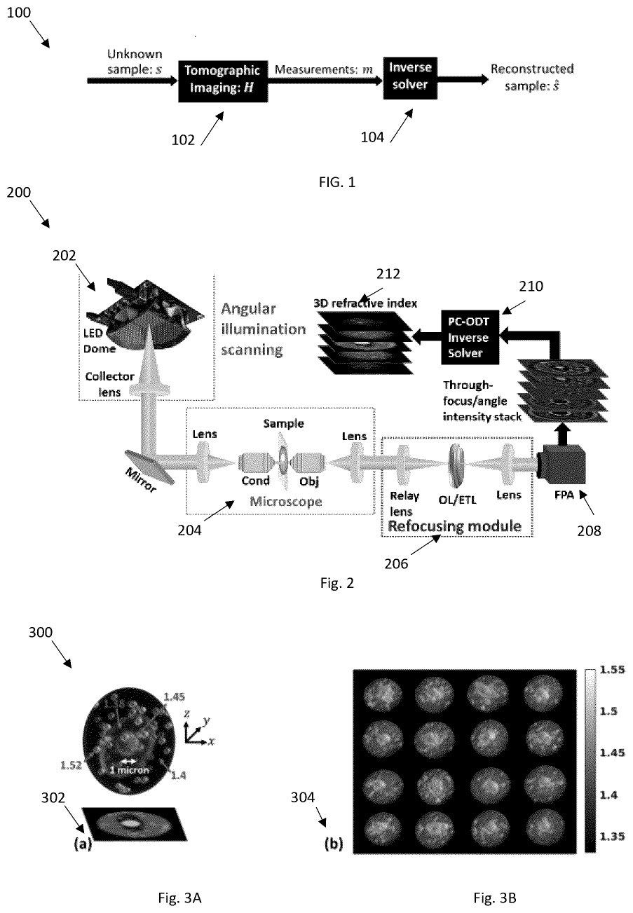

FIG. 1 depicts a tomographic inverse problem 100, where a forward model H 102 represents the entire tomographic imaging system that samples the measurement space M. Tomographic reconstruction can be realized by adopting the mathematical framework of an inverse problem 104. Inverse problem 104 attempts to solve for an unknown sample s using measurements m∈M generated from forward model H 102 operating on s, i.e. m=H(s). The inverse problem tries to find a solution

$$\hat{s} = \frac{m}{H} ,$$

ŝ∈S of the forward model m=H(s).

Optical diffraction tomography is an ill-posed inverse problem that entails computing the 3D refractive index from 2D scattering fields. The scattering problem can be defined by the inhomogeneous Helmholtz equation given by

$$( {∇}^{2} + {k}_{0}^{2} ) ψ ( r , z ) = - V ( r , z ) ψ ( r , z ) , \qquad ( 1 )$$

where k₀=2π/λ is the optical wavenumber, r=(x,y) are the transverse spatial coordinates, z is the axial dimension, ψ(r,z)=ψᵢ(r,z)+ψₛ(r,z) is the total field with contributions from the on-axis incident and scattered components, and V(r,z) is the complex scattering potential defined as

$$V ( r , z ) = {k}_{0}^{2} [ {n}^{2} ( r , z ) - {n}_{m}^{2} ] = ϕ ( r , z ) + i A ( r , z ) . \qquad ( 2 )$$

The scattering potential is a solution to the Helmholtz equation and is a function of the 3D complex refractive index n=nᵣₑ+inᵢₘ with amplitude and phase components given by A and ϕ. Using the first-order Born approximation, |ψₛ|<<|ψᵢ|, the total field can be solved for without explicit knowledge of the scattered component using the Green's function solution G(r,z) to the homogeneous equation for undiffracted light given by

$$ψ ( r , z ) = {ψ}_{i} ( r , z ) + [ V ( r , z ) {ψ}_{i} ( r , z ) ] * G ( r , z ) \qquad ( 3 )$$

$$G ( r , z ) = - exp ( i {k}_{0} \vert ( r , z ) \vert ) / ( 4 π \vert ( r , z ) \vert ) ,$$

where (*) denotes a convolution operation. The Born approximation neglects multiple-scattering and the total field is proportional to the interference of first-order diffraction with undiffracted light. More simply put, the Born approximation is valid when in-plane scattering dominates out-of-plane scattering, expressed in terms of field derivatives as ∇ᵣψ<<∇_{Z}ψ. The Fourier transform of the intensity of the total field can then be expressed as

$$ℱ \{ I \} = B δ ( ρ , η ) + \tilde{A} ( p , η ) {H}_{A} ( ρ , η ) + \tilde{ϕ} ( ρ , η ) {H}_{ϕ} ( ρ , η ) , \qquad ( 4 )$$

where Ã and \tilde{ϕ} and are the frequency domain representations of the amplitude and phase components of the scattered optical field, H_{Aϕ} are the amplitude and phase components of the 3D OTFs, and Bδ(ρ,η)) is the DC component of the corresponding background intensity B. The notation ρ=(k_{X}, k_{y}) corresponding to transverse spatial frequency components and η=k_{z} corresponding to the axial spatial frequency component were adopted. The amplitude and phase OTFs are given by

$${H}_{A} ( ρ , η ) = \frac{λ}{4 π} [ P ( ρ , η ) + P ( ρ , - η ) ] \qquad ( 5 a )$$

$${H}_{ϕ} ( ρ , η ) = \frac{i λ}{4 π} [ P ( ρ , η ) - P ( ρ , - η ) ] , \qquad ( 5 b )$$

where P is the 3D complex aperture function of the source and imaging optics. Under the assumption of weak diffraction and scattering, given by (∇ϕ/k₀)²<<Δn, the inverse problem can be solved assuming a phase-only contribution to the scattering potential which can be easily solved to provide the diffractive component of the refractive index nᵣₑ which determines the phase velocity in the sample where the imaginary component nᵢₘ representing the absorption coefficient has been ignored. The scattering inversion of Eq. (4) can then be represented as a 3D deconvolution given in inverse notation as \tilde{ϕ}= [symbol] {I}/H_{ϕ} In practice the inverse problem can be solved using the following least-squares energy minimization in the spatial domain,

$$\hat{n} ( r , z ) = {arg min}_{n ( r , z )} {\sum }_{m} {‖ \sqrt{{I}_{m} ( r )} - \vert {H}_{m} ( n ( r , z ) ) \vert ‖}^{2} + γ R ( n ( r , z ) ) , \qquad ( 6 )$$

where n(r,z) is the scattering potential represented as the 3D complex RI, Iₘ(r) are the 2D intensity measurements, Hₘ describes the [symbol] ³→ [symbol] ² forward model that predicts 2D field at the recording plane for measurement m, and R is a regularization function with tuning parameter γ.

By inspecting Eq. (6), an accurate inversion should require the 3D RI to be adequately encoded into 2D intensity measurements from a predictable model H. In addition, the measurements provide an adequate representation of the scattering kernel for robust inversion of the scattering process. In this disclosure, combining axial defocusing and optical beam steering provide measurements for tomographic inversion techniques with improved axial resolutions.

Coherent ODT has been demonstrated based on digital holographic microscopy and angular illumination diversity achieved using beam steering devices. The interferometric phase is encoded in the coherent spatial mixing of the path length matched object and reference beams and is trivially deduced in reconstruction. A simpler non-interferometric ODT realization, suitable for fully coherent sources and partially-coherent sources which generate spatially incoherent quasi monochromatic light was considered. Partial-coherence can be achieved directly using a filtered halogen lamp, LED array, or diffusing the beam of a spatially coherent laser source. The system described herein provides phase sensitivity without issues associated with interferometric optics including coherent optical speckle, mechanical instabilities, aberrations, and phase wrapping.

FIG. 2 shows the proposed non-interferometric ODT system 200. In this configuration, angular illumination is achieved by diversifying single diode illumination in a structured LED array 202. The partially-coherent angular illumination is focused on the object using transmission microscope optics 204 comprised of a condenser and objective lens. Without the need for a reference arm, an optical refocusing module 206 placed after interaction with the sample provides access to quantitative phase information by solving the TIE equation at axially displaced planes. The optical refocusing module 206 comprises a divergent offset lens and electronically tunable lens (OL/ETL) combination placed at the focal plane of a relay lens in a 4f imaging system. Altering the effective focal length of the OL/ETL pair is equivalent to but much faster than either axially translating the recording plane of the focal plane array (FPA) 208 or the sample stage resulting in a re-focusing at the object plane. Thus, the disclosed system provides an improvement in the measuring speed.

Intensity measurements are recorded as the effective focal length of the OL/ETL is varied to provide a focal scan across a variety of illumination projections provided by the illumination scanning module 202. The total number of measurements M is defined as the number of defocus planes M_{z} times the number of angles M_{θ}, i.e. M=M_{z}·M_{θ}. Adequate sampling to support both scanning modalities comes at the cost of increased time and computational complexity in both hardware and reconstruction implementations. Through-focus scanning using an ETL and angular scanning typically achieve 10-20 ms update rates. Measurement acquisition rates can also be limited by the integration time required to achieve high contrast intensity images collected through an objective lens, typically on the order of 100-400 ms for partially coherent sources. Measurement acquisition rates of 2.5-10 Hz are therefore expected; providing 100 measurements of axial and illumination diversity in 10-40 sec. To improve effective measurement throughput multi-diode coded illumination patterns can be used to improve reconstruction quality for a limited number of led scans, drastically reducing the time required to collect measurement support for sample inversion through the PC-ODT inverse solver 210.

Transmissive phase-sensitive imaging of biological samples is a well-suited application for ODT as such samples are often highly optically transparent with valuable information contained in the optical path length induced via propagation through the specimen. In this disclosure, the simulations of the 3D optical scattering potential and forward scattering process for samples that meet the requirements for ODT inversion are considered.

FIG. 3A shows the simulated phantoms 300 representing the phase-only scattering potential of nearly-spherical cells, as a 3D distribution of refractive index 302. The simulated samples are stochastically generated using over-resolved object-plane coordinates; stochastic sampling is guided by measured optical properties of cells and contains random distributions of sub-cellular organelles modeled as 3D ellipsoids. The complex object field is computed using plane wave illumination at 532 nm the imaging aperture of an objective lens is modeled using NA=1.4.

FIG. 3B shows 16 image-plane realizations of the simulated cells 304 convolved with the incoherent detector point spread function (PSF) and subsampled on the FPA 208; these can serve as ground truth in subsequent processing and analysis whereas the object plane representations can be used to generate image-plane intensity measurements through application of an optical scattering forward model. Transverse image sizes of 96×96 are considered, representing the FOV for a 10 micron sample assuming a pixel pitch of 6.5 microns and 60× magnification. Approximating the optical scattering process in the cell phantoms provides data for validation of 3D inverse scattering techniques.

Light propagation through homogeneous objects can be represented as the 3D convolution of the object scattering potential with the PSF for diffraction. By the mathematical nature of the convolution, this model only, accounts for first-order scattering effects or equivalently light scattered light once in all dimensions. To compute optical scattering through inhomogeneous objects, a multi-slice beam propagation model (MSBP) implementation of the tomographic forward operator that accounts for multiple-scattering along the axis of propagation was considered. The model approximates 3D objects as thin layers and computes the optical field as sequential layer to layer propagation. While the model considered does not account for out-of-plane scattering or plane-to-plane absorption, it does represent multiple in-plane scattering by computing the scattered field iteratively at each plane and is a suitable representation of the optical scattering process in biological samples.

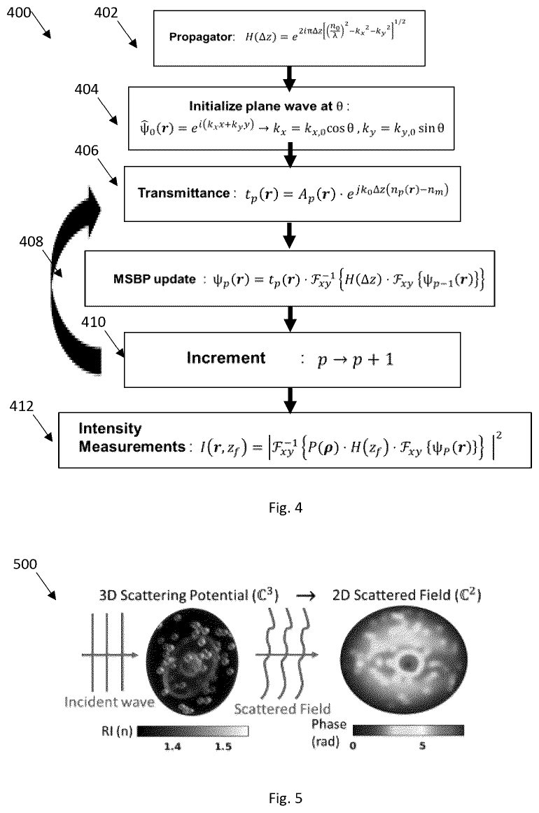

FIG. 4 describes the mathematical form of the MSBP algorithm 400. Sequential plane-to-plane propagation allows for the inclusion of multiple in-line scattering effects. The axial dimension in the plane-to-plane propagation scheme is represented using the z-plane indices p, e.g. n(r,z)=n_{1:p}(r). The propagator is defined in 402. A plane wave is incident on the object at an angle θ=(θₓ, θ_{y}) relative to the transverse coordinates 404. The scattered field ϕₚ(r) 408 is computed by applying the scattering potential in the form of a transmittance function 406 at each slice in a plane-to-plane propagation scheme 410. The composite scattered field is then propagated forward a distance z_{f} to the final defocusing plane 412 where a generalized pupil function is applied corresponding to both the imaging and detection optics.

FIG. 5 presents a visual representation of the forward scattering process 500. The phase of the scattered field is shown to demonstrate plane-to-plane phase scattering effects. In general the forward operator provides the complex [symbol] ³→ [symbol] ² scattering transformation. However, for weak phase objects only the real-valued refractive index contributes to the scattering potential and the magnitude of the scattered field encodes phase-diffraction information. The modulus-squared operation is returned to represent intensity measurements from a photosensitive FPA 208.

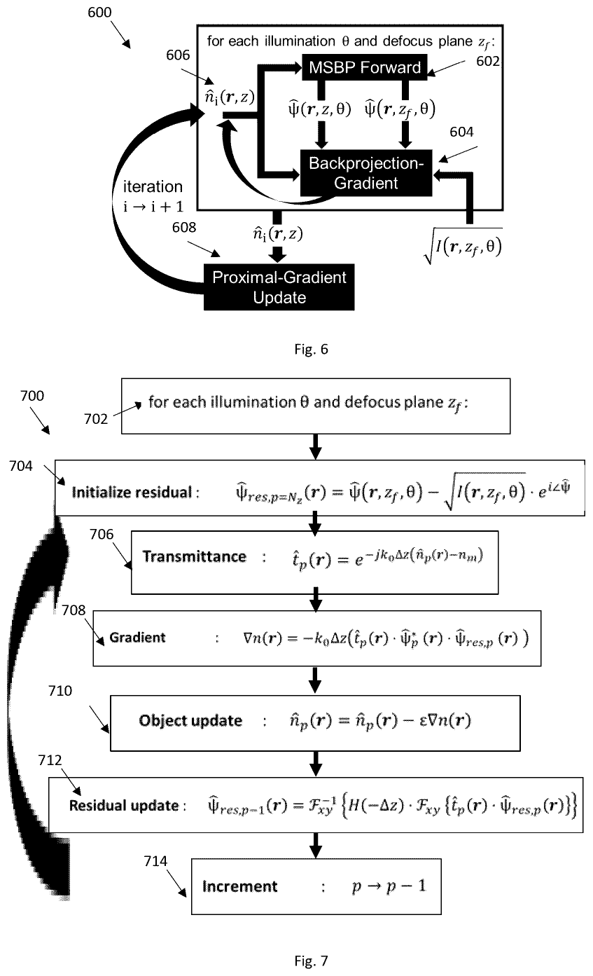

FIG. 6 outlines the ODT-Gradient inverse approach 600. During each iteration the reconstruction is sequentially updated in the direction of measurements using a gradient-descent method. TV regularization is implemented after each iteration using a proximal-gradient update to the reconstruction The minimization problem in Eq. (6) describes a scattering inversion framework that can be solved using an iterative approach based on plane-to-plane forward-backward projection and gradient descent optimization. The model is comprised of a forward component 602 that predicts the 3D complex field \hat{ψ}(r, z, θ) and 2D complex measurements \hat{ψ}(r, z_{f}, θ) from the 3D reconstructed RI \hat{n}(r,z), and an inverse backpropagation-gradient solver 604 which re-estimates the scattering potential from the 3D complex field predictions supported by the through-focus/angle intensity measurements I(r,z_{f}, θ). In reconstruction, an estimate using the hat operator is denoted. The forward and backward scattering projections are modeled using the multi-slice beam propagation model 400 described previously, herein, however in reconstruction the forward operator operates on the estimated scattering potential to provide access to the 3D complex scattered field and complex measurements, as opposed to intensity-only measurements. During each iteration, the estimate of the refractive index is successively updated in the direction of minimization for each measurement. After each iteration, total-variation (TV) regularization using the L² norm of the 3D refractive index 606, corresponding to R in Eq. (6), is implemented using a proximal gradient method 608 to update to the object reconstruction. This allows for a momentum-based acceleration of the gradient in convex regularization problems.

FIG. 7 describes the scattering estimates from the forward model that are used in conjunction with the intensity measurements to update the complex object reconstruction during the back-projection gradient update 700. For a forward-prediction at each illumination angle θ and defocus plane z_{f}, 702 the residual 704 is initialized as the difference between the complex measurements as predicted by the forward model and the observed measurements. In lieu of complex observations, the residual is initialized by enforcing the phase as predicted by the forward model applied to the square-root of the intensity measurements. The transmittance is defined in 706. For each axial plane p in a plane-by-plane back-propagation scheme, the complex field predicted by the forward model is ‘inverse-scattered’ according to the current estimate scattering potential. The gradient 708 is then computed using the residual and subtracted from the previous estimate of the object reconstruction, as to achieve an object update 710 against the gradient in the direction of minimization using the gradient step-size ε. Finally, the residual is back-projected 712 to the previous plane and the algorithm repeats 714.

CNNs provide a deep regularization solution to replace the proximal-gradient update method in FIG. 6. In this implementation the network is trained to map the low-to-high resolution transformation provided by regularization routines. Similarly, iterative tomographic inversion has been demonstrated using CNN architecture that is trained in-situ to learn minimization using a “deep physics prior” loss function as an alternative to solving a regularized optimization problem directly. Both solutions address the missing cone problem by alleviating rigid dependence on scattering model approximations. To address the shortcomings of traditional optimization routines the current disclosure proposes to use CNN architecture to directly map intensity measurements to refractive index, thus providing a full representation of scattering inversion from intensity only measurements.

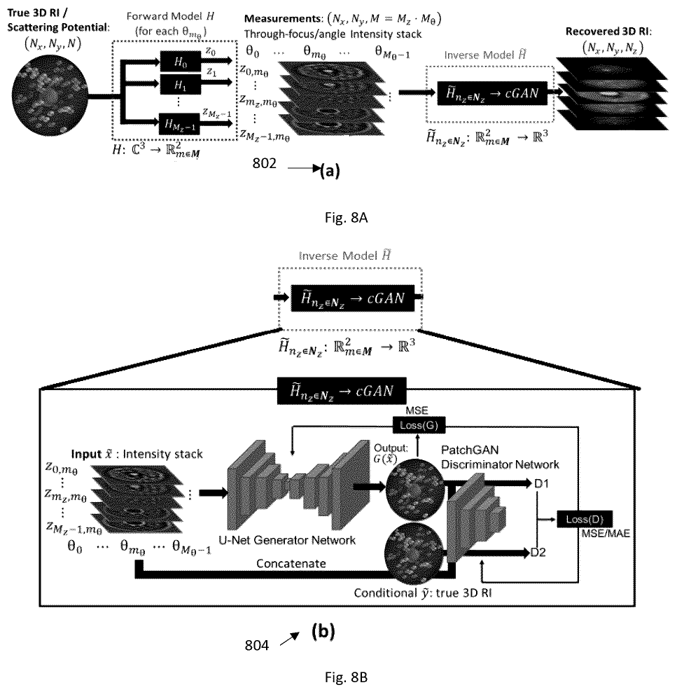

FIG. 8A shows the proposed architecture 802 for non-interferometric-ODT imaging and reconstruction applied to a simulated cell phantom. To acquire RI slices from a stack of intensity images the pix2pix conditional generative adversarial network (cGAN) architecture 804 is adopted. The complex optical field de-focused to a plane z_{mzmθ} is generated and measured as intensity by the [symbol] ³→ [symbol] ² forward model (H_{mz}) operating on the 3D object scattering potential, described by the multi-slice beam propagation forward model. The composite forward model H=(H₀, . . . , H_{M=MzMθ}) provides a series of 2D measurements as the object is scanned through focus and angle, i.e. H: [symbol] ³→ [symbol] _{m∈M}² where M is the measurement set.

FIG. 8B shows the non-linear inverse model \tilde{H}_{nz∈Nz} [symbol] _{m∈M}²→ [symbol] ³ implemented as a fully connected cGAN 804 based on 3D convolution/deconvolution to achieve stack-to-volume translation for a set of z-plane reconstructions N _{z}. The forward model generates a series of through-focus and angle intensity measurements, which are translated to a 3D RI volume in the inverse model. Each node in the forward mode is a MSBP forward operator which provides an intensity measurement defocused to a plane zₘ_{_{z}}_{,m}_{_{θ}} from incident illumination at an angle θₘ_{_{θ}}. The inverse model is implemented as a trained cGAN with a generator network (U-Net) to provide volumetric RI prediction for a set of reconstruction planes zₘ_{_{z}}_{∈N}_{_{z}}. The training is optimized using a discriminator network (PatchGAN) and conditioned using image labels.

GANs comprise two adversarial models: a generative model G learns the data distribution and is trained to produce outputs that cannot be distinguished from “real” images by an adversarially trained discriminator model D. The discriminator is trained to identify “fake” images produced by the generator and estimates the likelihood that a sample belongs to the training data; e.g., GANs learn a mapping from a random noise vector \tilde{z} to an output image \tilde{y}, i.e. G: \tilde{z}→\tilde{y}. Conditional GANs use auxiliary information to condition the generator and discriminator to continuously optimize network parameters and learning; cGANs learn a mapping from an observed image \tilde{x} and random noise vector \tilde{z}, to an output image \tilde{y}, i.e. G: {\tilde{x},\tilde{z}}→\tilde{y}.

The training procedure implemented in the cGAN architecture 804 is shown in FIG. 8B. The generator output G(\tilde{x}) and input images x are concatenated and input to the discriminator network to generate a mapping function D1. The input images and the conditional y, in this case comprised of the label images or desired generator outputs, are concatenated and input to the discriminator network to generate a mapping D2. The feature mappings D1 and D2 are used to construct the loss function of the discriminator. The generator output, conditional, and feature mapping D1 are used to construct the loss function of the generator. The composite objective of a conditional GAN can be expressed as

$${ℒ}_{c G A N} ( G , D ) = {𝔼}_{\tilde{x} , \tilde{y}} [ log D ( \tilde{x} , \tilde{y} ) ] ) + {𝔼}_{\tilde{x} , \tilde{z}} [ log ( 1 - D ( \tilde{x} , G ( \tilde{x} , \tilde{z} ) ) ) ] , \qquad ( 7 )$$

where [symbol] is the expectation operator. The generator attempts to minimize the objective against an adversarial discriminator that tries to maximize it, e.g.

$${G}^{*} = arg {min}_{G} {max}_{D} {ℒ}_{cGAN} ( G , D ) . \qquad ( 8 )$$

The use of the discriminator in the min-max objective function provides an excellent model for image-to-image prediction as the conditioned network can represent sharp features, high resolution/high frequency content, even degenerate distributions whereas simpler models with commonly used pixel-wise loss functions require blurry distributions. It has been proven beneficial to regularize the objective function using the mean absolute error (MAE) as the L1 norm can further discourage blurring. The final objective is given by

$${G}^{*} = arg {min}_{G} {max}_{D} {ℒ}_{cGAN} ( G , D ) + {γ}_{G} {ℒ}_{MAE} ( G ) , \qquad ( 9 )$$

where the L1 loss function is given by

$${ℒ}_{M A E} ( G ) = {E}_{\tilde{x} , \tilde{y} , \tilde{z}} [ {‖ \tilde{y} - G ( \tilde{x} , \tilde{z} ) ‖}_{1} ] . \qquad ( 10 )$$

The regularization parameter γ_{G}=100 is used to penalize generator mismatch with the conditional labeled data. The cGAN network trained using L1 minimization can learn to create a solution that resembles realistic high-resolution images with high-frequency details. Network prediction is achieved by applying the trained generator to testing images. The networks are trained using 240 input/output image-stack pairs and tested using 64 hold-out samples. Each training example comprised of the intensity measurement stack and 3D RI. For each training epoch, i.e. when each training sample has propagated through the network at least once, the model parameters are updated for each batch of training images using gradient descent optimization and back-propagation. The Adam algorithm is used for stochastic optimization with a learning rate of 0.0002 and momentum parameters β₁=0.5, β₂=0.999.

While cGAN is a powerful mathematical construct for image generation, there are common convergence failure mechanisms that can degrade the quality of the generated images. The fundamental GAN failure mechanism is mode collapse. Mode collapse arises from the adversarial training strategy, when the generator is over-optimized to produce only a small subspace of plausible outcomes, or dominant modes, that the discriminator has learned to easily identify as a “fake”. Consequently, the discriminator lacks training support to adequately learn the full mapping of plausible input/output translations. In training, the discriminator converges to a local minimum and does not incentivize the generator to produce non-dominant modes required to adequately train the network. Conditional GANs attempt to minimize this effect by processing the generator output and conditional images through the discriminator independently, and defining a composite loss function for optimization. While the issue of mode collapse has not fully been solved, more advanced mitigation strategies have received much attention in the machine learning community, including unrolled GANs which additionally include future discriminator outputs in the loss function to prevent over-optimization. A distinct challenge is feature hallucination, which occurs if the generator has learned numerical mappings that are inconsistent with the true bounds of physics based forward and inverse scattering. Feature hallucinations can arise when training datasets contain large sample-to-sample variations and contain even small biases and noise. Increasing the regularization parameter γ_{G} in (9) would further penalize prediction mismatch with the labeled data, effectively desensitizing the learning process and de-motivating feature hallucinations, perhaps at the cost of robust network prediction for samples that are not well represented in the training data.

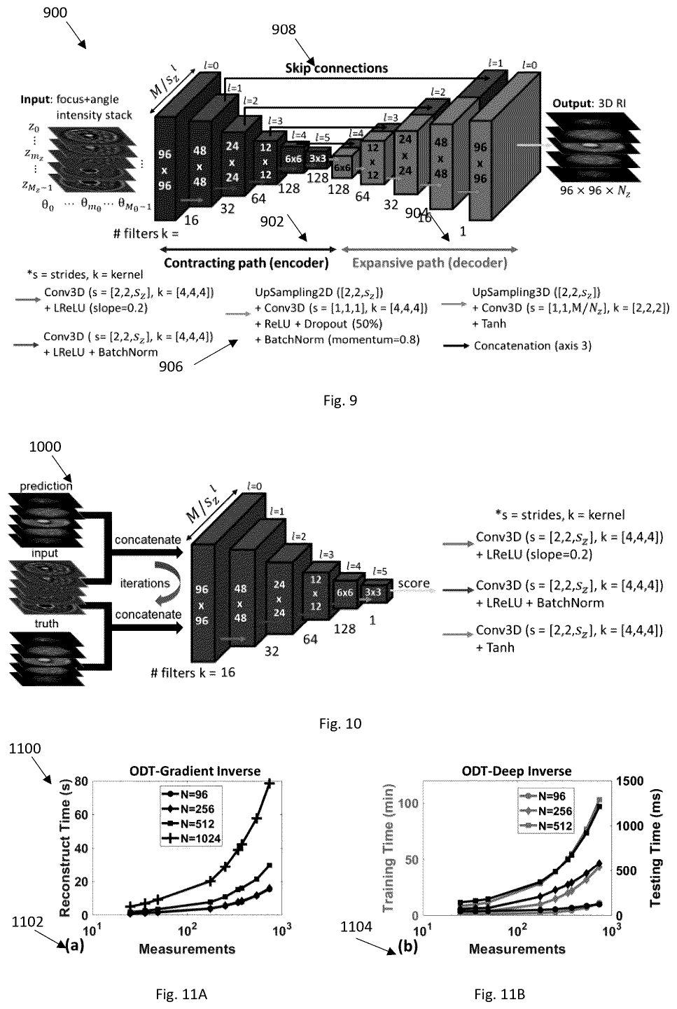

FIG. 9 shows the generator network implementation is the U-Net architecture, based on the fully convolutional network 900. Skip connections between mirrored layers, depicted as black arrows, provide access to additional low-level information. Network 900 comprises a contracting path or encoder 902 and an expansive path or decoder 904. The encoder and decoder follow CNN architectures as would be understood by one of ordinary skill in the art. The contracting path 902 comprised of repeated applications of 4×4×4 3D spatial convolutions with 3D downsampling, each followed by a leaky rectified linear unit (LReLU) activation function to alleviate the vanishing gradient problem and improve learning efficiency. At each layer in the contracting path the data is down-sampled using stride 2 in the transverse dimensions with variable stride s_{z} in the axial dimension depending on the number of measurements. At each downsampling step the number of feature channels (e.g., the number of independent 3D spatial filters in the network node) is doubled from 16 to 128. The size of the data at each layer in the network is then (96/2^{l}, 96/2^{l}, M/s_{z}^{l}), with the final layer in the encoder producing 3×3×1 transverse image patches. Every step in the expansive path 904 comprised of an up-sampling of the feature map followed by a 4×4×4 convolution (“up-convolution”) with single pixel stride that halves the number of feature channels from 128 to 16. At layer interfaces in the expansive path ReLU activation functions are enforced with 50% dropout rate. After the last decoder layer, a 3D convolution is applied to map to the number of output channels and a Tanh activation function is applied to acquire the volume prediction. The network comprises 10 total layers; batch normalization is performed at each layer interface in the encoder and decoder paths to standardize the data, stabilize and improve network training. The operations performed at each layer interface are detailed in legend 906 of FIG. 9. While classical CNN solutions require information to flow through the entire encoder/decoder structure; the “U-Net” implementation provides skip connections 908 between mirror symmetric layers in the encoder/decoder. Skip connections 908 are a way to protect the information from loss during transport in neural networks and provide access to low level information which is crucial for image representation.

To further enforce high spatial frequency representation pix2pix adopts the well-known PatchGAN discriminator framework, which only penalizes structure at the scale of local image patches. The discriminator is run for a series of convolution patches across the image, averaging all responses to provide an aggregate likelihood that, each 3×3×1 patch is a real image produced by the generator. By assuming independence between pixel separations which are large relative to the patch size, the network can learn higher order image texture.

FIG. 10 shows the discriminator network 1000 which mimics the first five convolutional layers in the contracting path 902 of the generator network 900; the number of feature channels doubles from 16 to 128. The final layer in the discriminator network 1000 applies a Tanh activation function to 3×3×1 patches to generate class likelihood scores that feed the cGAN loss function described previously herein and train the Generator network 900 described previously herein. The discriminator is run for a series of convolution patches across the image and only penalizes structure at the scale of local image patches.

All exemplary results were generated using a Linux based system with Intel Xeon W-2295 18 core (36 thread) processor operating at 3.00 GHz base frequency with 64 GB of RAM. To accelerate computations, both ODT inversion algorithms were executed using a NVIDIA RTX A5000 GPU with 24 GB RAM and 8192 CUDA cores. The algorithms were developed using Python 3.9.7 and CUDA Toolkit 11.6. ODT-Gradient inverse utilizes CuPy 9.6.0 for GPU accelerated computing. The cGAN architecture for the ODT-Deep inverse framework was implemented using the TensorFlow (v2.8.0) framework; matrix operations were implemented using single-precision (32-bit) floating point operations evaluated across CUDA cores.

FIGS. 11A-B shows the time complexity of ODT-Gradient inverse 1102 and ODT-Deep inverse 1104 implemented on the GPU. Algorithm timing is performed for 3D RI profiles with N_{z}=96 axial planes and N root pixels per image, performance is shown for increasing number of measurements and image sizes. FIG. 11A shows the reconstruction time per iteration for ODT Gradient inverse 1102. FIG. 11B predicts the time complexity of ODT-Deep inverse 1104, the training time per epoch (black) using 240 input/output image-stack pairs and testing time per sample (red) are shown. For N=96, network training per epoch is 1-10 min and measurement stack to RI volume prediction is performed in less than 100 ms for up to several hundred measurements. The total time to reconstruct a full 3D object is then significantly decreased relative to ODT-Gradient inverse 1102, which takes 225 sec to iterate and converge to a 96×96×96 3D reconstruction using 400 total measurements and 25 iterations. For moderate image sizes (N>128), ODT-Gradient reconstruction time 1102 is dominated by the series of plane-to-plane 2D spatial FFTs exhibiting (N²·N_{z}) log(N²) complexity. ODT-Deep inverse 1104 is dominated by layers of 3D convolutions, with the most intensive exhibiting ([N+k]²·[N_{z}+k]) log([N+k]². [N_{z}+k]) complexity for filter size k. Computational limitations are reached for N>512 due to extensive training times and limited GPU memory to store training measurements and volumes, highlighting a main disadvantage of pre-trained 3D neural networks.

A 3D refractive index reconstruction and prediction is considered using through-focus and angle measurement simulations of the optical system described in FIG. 2 and optical scattering described previously herein.

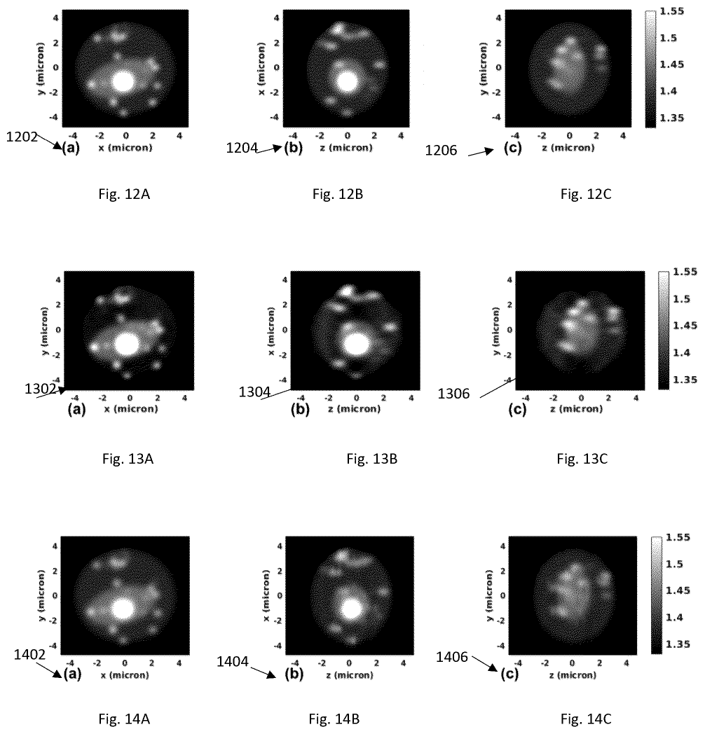

FIGS. 12A-C show 2D slices through the true RI of a simulated cell phantom 1200. FIG. 12A shows a first slice 1202 (transverse (x-y) slice). FIG. 12B shows a second slice 1204 (axial (x-z) slice). FIG. 12C shows a third slice 1206 (axial (y-z) slice) of a simulated cell phantom 1200. The forward model is applied to the 3D scattering potential to generate intensity measurements which are used as' support for the tomographic inversion processes. As a representative example, 252 measurements are considered. These measurements comprised of M_{z}=7 defocus planes spanning ±3.3 micron for each of M_{θ}=36 illumination angles spanning (−60,60) degrees in both transverse spatial dimensions, e.g., 6 angles relative to x and y coordinates, respectively. For alternate measurement sets, the de-focus and angular scanning range remained fixed at ±3.3 microns and (−60,60) degrees respectively, with increasing resolution for increasing measurements.

FIGS. 13A-C show 2D slices through the reconstructed RI using, ODT-Gradient inverse after 25 optimization iterations 1300. FIG. 13A shows a first slice 1302 (e.g., transverse (x-y) slice); FIG. 13B shows a second slice 1304 (e.g. axial (x-z) slice) and FIG. 13C shows a third slice 1306 (axial (y-z) slice) of the reconstructed RI using ODT-Gradient inverse 600. The gradient solver timed 6 sec/iteration to perform 3D object reconstruction with N_{z}=96 axial planes.

FIGS. 14A-C show 2D slices through the reconstructed RI predicted by ODT-Deep inverse after 100 training epochs 1400 and the same measurements as' considered in FIGS. 13A-C. FIG. 14A shows a first slice 1402, FIG. 14B shows a second slice 1404, and FIG. 14C shows a third slice 1406 of the reconstructed RI using ODT-Deep inverse 800. Network training was executed at a rate of 165 sec/epoch, however the meantime to test a sample and predict a volume with N_{z}=96 axial planes was just 68 ms.

Comparing respective slices from FIGS. 12A-C, FIGS. 1′3A=C, and FIGS. 14A-C, the ODT-Gradient inverse 600 suffers from blurring and reconstruction biases that are not present in the ODT-Deep inverse 800 reconstruction.

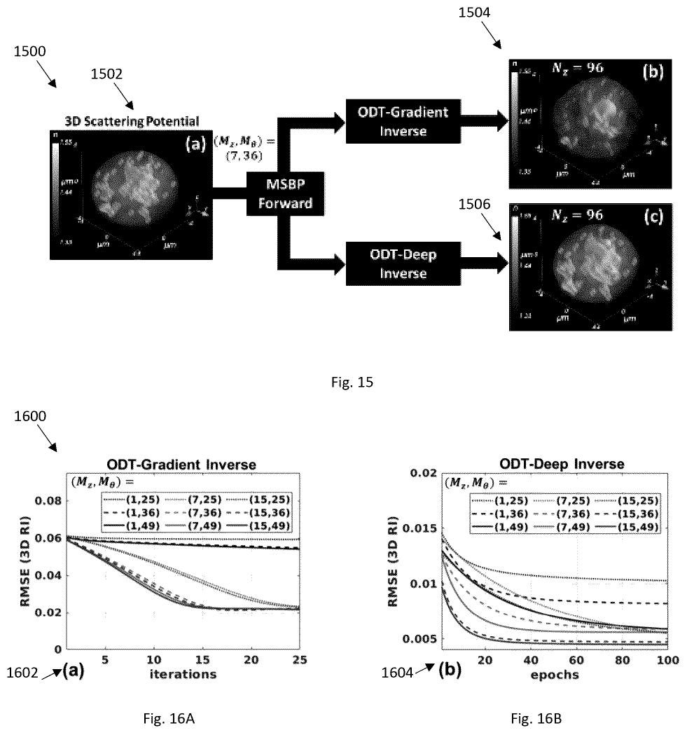

FIG. 15 is a schematic that illustrates the scattering flow 1500. A 3D rendering of the forward scattering potential is indicated by label 1502. A 3D rendering of the scattering inversion based on the ODT-Gradient inverse 600 is indicated by label 1504. A, 3D rendering 1506 of the scattering inversion based on the ODT-Deep inverse 800 is indicated, by label 1506. The 3D projection further demonstrates that ODT-Deep inverse 800 reconstructs the original 3D refractive index 1502 with minimal blurring and less overall biases relative to ODT-Gradient inverse 600. Furthermore, many inhomogeneities that are missing from rendering 1504 are fully resolved using the network based approach as shown by 1506. Deep learning based reconstruction is not without artifacts, as seen by faint vertical striping in FIGS. 14B and 14C 1404,1406. The artifacts were found to become less pronounced with increasing training examples and training iterations, at the cost of increased computational resources and extended training times.

Measurements are, generated using the multiple-scattering forward model applied to the 3D scattering potential (a); 3D RI is reconstructed using ODT-Gradient inverse (b) and ODT-Deep inverse (c),

FIG. 16A shows the RMSE for the ODT-gradient inverse. The individual line plots correspond to various measurement sets, shows the root-mean-square error (RMSE) 1602 of the 3D RI reconstruction relative to the true scattering potential aggregated using 64 testing samples for ODT-Gradient inverse 600 as a function of optimization iteration and FIG. 16B shows the root-mean-square error (RMSE) 1604 of the 3D RI reconstruction relative to the true scattering potential aggregated using 64 testing samples ODT-Deep inverse 800 as a function of training epochs. Increased axial and illumination diversity independently improved the quality of reconstruction for both approaches. Increased axial-scanning support for ODT-Gradient inverse 600 improved the convergence for sufficiently high illumination diversity. ODT-Gradient inverse 600 ultimately becomes limited by the numerical inaccuracies of the non-deterministic optimization routine for sufficiently large measurement sets, achieving minimum RI errors on the order of 2e-2. The minimum achievable reconstruction error for ODT-Deep inverse 800 was found to be 4× below this bound. All results assume a microscope objective function with NA=1.4, demonstrating robust reconstruction performance for-high resolution imaging.

Non-interferometric phase microscopy significantly decreases the complexity of 2D/3D quantitative imaging systems. Measuring a stack of through-focus intensity images can provide high fidelity phase contrast images for samples that meet the requirements' of the first-Born approximation. 3D RI retrieval methods exist for focus-scanning systems, however with drastically reduced axial resolution relative to systems that measure illumination diversity. In this disclosure, advanced tomographic RI retrieval approaches are designed to meet the unique challenges of non-interferometric ODT systems. To provide support for scattering inversion techniques through-focus and angle scanning diversity are considered to encode a more complete 3D representation into the 2D scattered fields with improved spatial resolution relative to illumination-scanning only systems. High-fidelity 3D RI images were acquired using advanced software solutions to provide high-fidelity tomographic reconstruction for large datasets comprised of 3D input/output images.

This disclosure demonstrates accurate 3D refractive index retrieval achieved by inverting the optical scattering process using non-interferometric measurements and an ODT-Deep inverse model based entirely on DL/CNN. The model comprises a pre-trained 3D cGAN network which translates 2D intensity measurements to a 3D RI volume. Achieving a fully-learned representation of optical scattering inversion improves errors associated with an incomplete sampling of the forward scattering kernel, scattering approximations, and numerical instabilities which arise from solving a non-deterministic constrained optimization problem.

As is often the case with DL solutions, the performance can be bounded by the quality of the output images used in training. Using simulations' of the phase-only scattering potential for biological samples, improved performance relative to a constrained optimization approach based on a multiple in-plane scattering model and regularized gradient descent is demonstrated. While training ODT-Deep inverse requires significant time and computational resources, a significant decrease in reconstruction error and three-orders of magnitude reduction in post-training reconstruction time relative to ODT-Gradient inverse is demonstrated. However, DL generated data can exhibit inaccuracies and feature hallucinations caused by the presence of noise and over-optimization. The results show that increased axial and illumination diversity both significantly improve the quality of reconstruction. The implementation of ODT-Gradient inverse is shown to ultimately become limited by the numerical inaccuracies of the non-deterministic optimization routine for sufficiently large measurement sets; the minimum achievable reconstruction error for ODT-Deep inverse was found to be well below this bound. Additionally, increased axial-scanning is shown to improve the convergence in terms of number of training epochs for sufficiently high illumination diversity.

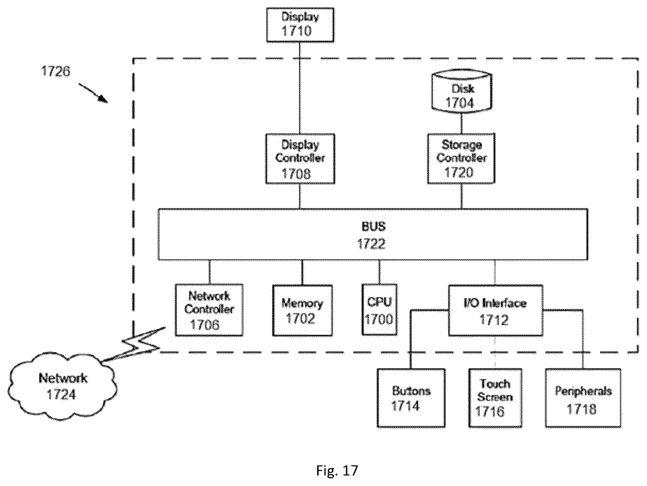

In one implementation, the functions and processes of the processor may be implemented by a computer 1726. Next, a hardware description of the computer 1726 according to exemplary embodiments is described with reference to FIG. 17. In FIG. 17, the computer 1726 includes a CPU 1700 which performs the processes described herein. The process data and instructions may be stored in memory 1702. These processes and instructions may also be stored on a storage medium disk 1704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 1726 communicates, such as a server or computer.

Further, the claimed advancements may be provided as a utility application, background daemon, or component of an operating system, or combination thereof, executing in conjunction with CPU 1700 and an operating system such as Microsoft® Windows®, UNIX®, Oracle® Solaris, LINUX®, Apple macOS® and other systems known to those skilled in the art.

In order to achieve the computer 1726, the hardware elements may be realized by various circuitry elements, known to those skilled in the art. For example, CPU 1700 may be a Xenon® or Core® processor from Intel Corporation of America or an Opteron® processor from AMD of America or may be other processor types that would be recognized by one of ordinary skill in the art. Alternatively, the CPU 1700 may be implemented on an FPGA, ASIC, PLD or using discrete logic circuits, as one of ordinary skill in the art would recognize. Further, CPU 1700 may be implemented as multiple processors cooperatively working in parallel to perform the instructions of the inventive processes described above.

The computer 1726 in FIG. 17 also includes a network controller 1706, such as an Intel Ethernet PRO network interface card from Intel Corporation of America, for interfacing with network 1724. As can be appreciated, the network 1724 can be a public network, such as the Internet, or a private network such as LAN or WAN network, or any combination thereof and can also include PSTN or ISDN sub-networks. The network 1724 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 1726 further includes a display controller 1708, such as a NVIDIA® GeForce® GTX or Quadro® graphics adaptor from NVIDIA Corporation of America for interfacing with display 1710, such as a Hewlett Packard® HPL2445w LCD monitor. A general purpose IO interface 1712 interfaces with a keyboard and/or mouse 1714 as well as an optional touch screen panel 1716 on or separate from display 1710. General purpose I/O interface also connects to a variety of peripherals 1718 including printers and scanners, such as an OfficeJet® or DeskJet® from Hewlett Packard®.

The general purpose storage controller 720 connects the storage medium disk 1704 with communication bus 1722, which may be an ISA, EISA, VESA, PCI, or similar, for interconnecting all of the components of the computer 1726. A description of the general features and functionality of the display 1710, keyboard and/or mouse 1714, as well as the display controller 708, storage controller 1720, network controller 706, and general purpose I/O interface 1712 is omitted herein for brevity as these features are known.

The features of the present disclosure provide a multitude of improvements in the technical field of 3D digital microscopy. In particular, the controller may remove aberrations (less blurring and inhomogeneities) and from the collected samples. The methodology described herein could not be implemented by a human due to the sheer complexity of data, gathering and calculating and includes a variety of novel features and elements that result is significantly more than an abstract idea. The methodologies described herein are more robust to inaccuracies. The method described herein may be used for early cancer detection. Thus, the implementations described herein improve the functionality of a 3D digital microscope by mitigating aberrations, and reducing blurring, and acquiring high-resolution in the acquired images. Thus, the system and associated methodology described herein amount to significantly more than an abstract idea based on the improvements and advantages described herein.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system comprising:
an illumination system configured to generate an illumination beam to illuminate a target at a plurality of illumination angles;
an optical system to direct the illumination beam to the target;
a refocusing system positioned in a detection path and configured to perform stageless axial refocusing of a measurement beam, wherein the measurement beam is transmitted through the target;
a detection system configured to capture an intensity stack for the plurality of illumination angles and during the axial refocusing; and
a processor configured to generate a three dimensional refractive index of the target based on the intensity stack.

2. The system of claim 1, wherein the illumination system comprises a light emitting diode (LED) dome array and wherein the LED dome array comprises a plurality of LEDs.

3. The system of claim 2, wherein each LED of the LED dome array is individually controlled; and
wherein an illumination time of each respective LED is controlled by the processor during measurement.

4. The system of claim 3, wherein two or more LEDs are simultaneously activated during measurement to increase a throughput of the system.

5. The system of claim 1, wherein the illumination beam is partially coherent.

6. The system of claim 1, wherein the optical system comprises an objective lens.

7. The system of claim 1, wherein the refocusing system comprises, a divergent offset lens and an electronically tunable lens.

8. The system of claim 7, wherein the refocusing system does not comprise moving mechanical parts.

9. The system of claim 7, wherein the refocusing system further comprises a relay lens system; and
wherein the offset lens and the electronically tunable lens are positioned in the detection path at a focal plane of the relay lens system.

10. The system of claim 1, wherein the three dimensional refractive index is generated using a trained neural network model, and wherein the intensity stack is an input to the trained neural network model.

11. The system of claim 1, wherein training the neural network model comprises:
generating intensity patterns through propagating illumination beams at the plurality of illumination angles through a sample and at a plurality of focus length of the refocusing system; and
reconstructing the respective three dimensional refractive index using a gradient based technique.

12. The system of claim 11, wherein the intensity patterns are generated through a simulation of the system and wherein the sample is a phantom.

13. The system of claim 11, wherein the neural network model is trained using biological samples.

14. The system of claim 1, wherein the intensity stack represents a plurality of intensity images captured by the detection system for the plurality of illumination angles and for a plurality of focus length of the refocusing system.

15. A digital microscope comprising:
an illumination system configured to generate an illumination beam to illuminate a target at a plurality of illumination angles;
an optical system to direct the illumination beam to the target;
a refocusing system positioned in a detection path and configured to perform stageless axial refocusing of a measurement beam, wherein the measurement beam is transmitted through the target;
a detection system configured to capture an intensity stack for the plurality of illumination angles and during the axial refocusing; and
a processor configured to generate a three dimensional refractive index of the target based on the intensity signal.

16. The digital microscope of claim 15, wherein the refocusing system comprises a divergent offset lens and an electronically tunable lens.

17. The digital microscope of claim 16, wherein the electronically tunable lens is a tunable liquid crystal lens.

18. The digital microscope of claim 16, wherein the refocusing system does not comprise moving mechanical parts.

19. A method for determining a three dimensional refractive index of a target, comprising
illuminating the sample at a plurality of illumination angles using an partially incoherent beam;
performing stageless axial refocusing of a measurement beam, wherein the measurement beam is transmitted through the target;
capturing an intensity stack for the plurality of illumination angles and during the axial refocusing; and
generating the three dimensional refractive index of the target using a trained neural network.

20. The method of claim 16, wherein training the neural network comprises:
generating intensity patterns through propagating illumination beams at the plurality of illumination angles through a sample and at a plurality of focus length of the refocusing system; and
reconstructing the respective three dimensional refractive index using a gradient based technique.
